(19) United States
(12) Patent Application Publication
(10) Pub. No.: US 2021/0089305 A1
(43) Pub. Date: Mar. 25, 2021

(54) INSTRUCTION EXECUTING METHOD AND APPARATUS

(71) Applicant: ALIBABA GROUP HOLDING LIMITED, George Town, KY (US)

(72) Inventors: Yimin LU, Hangzhou (CN); Xiaoyan Xiang, Shanghai (CN)

(21) Appl. No.: 17/028,352

(22) Filed: Sep. 22, 2020

(30) Foreign Application Priority Data
Sep. 25, 2019 (CN) 201910912624.3

(51) Int. Cl. G06F 9/30; G06F 9/34; G06F 9/38

(52) U.S. Cl. CPC G06F 9/30043; G06F 9/3802; G06F 9/34

(57) ABSTRACT

Embodiments of the present disclosure provide methods and apparatuses for an instruction executing method. The method can include: receiving an address-unaligned data load instruction, the data load instruction instructing to read target data from a memory; acquiring a first part of data of the target data from a buffer; acquiring a second part of data of the target data from the memory; and merging the first part of data and the second part of data to obtain the target data.

### CROSS-REFERENCE TO RELATED APPLICATIONS

The present disclosure claims priority to Chinese patent application No. CN 201910912624.3, filed on Sep. 25, 2019, which is incorporated herein by reference in its entirety.

### BACKGROUND

A processor is generally able to execute an instruction to access a memory. For example, a processor can execute data load instructions to read data from a memory.

For some processors, especially a Reduced Instruction Set Computer (RISC) processor, when a data load instruction is executed, an address of data to be read by the instruction must be an integer multiple of a data length, that is, the address must be aligned. If the data load instruction is address unaligned, an exception can occur.

For such an address-unaligned data load instruction, a conventional processing method is to split the address-unaligned data load instruction into two accesses to a memory, and merge data obtained by the two accesses to obtain an execution result of the instruction. However, modern processors or processor cores process instructions in a pipelined manner Conventional processing methods can occupy a processor pipeline twice, and both the execution speed and execution efficiency can be relatively low. Moreover, due to multiple accesses to the memory, the performance of the processor can be greatly reduced, resulting in high power consumption.

### SUMMARY OF THE DISCLOSURE

The embodiments of the present disclosure provide methods for an instruction executing method. The method can include: receiving an address-unaligned data load instruction, the data load instruction instructing to read target data from a memory; acquiring a first part of data of the target data from a buffer, the first part of data being data of a first plurality of bits in the target data; acquiring a second part of data of the target data from the memory, the second part of data being data of a second plurality of bits in the target data; and merging the first part of data and the second part of data to obtain the target data.

### BRIEF DESCRIPTION OF THE DRAWINGS

The accompanying drawings described herein are used to provide further understanding of the present disclosure and constitute a part of the present disclosure. Exemplary embodiments of the present disclosure and descriptions of the exemplary embodiments are used to explain the present disclosure and are not intended to constitute inappropriate limitations to the present disclosure. In the accompanying drawings:

FIG. 1 is a schematic diagram of exemplary instruction processing apparatus 100 according to some embodiments of the present disclosure.

FIG. 2 is a schematic diagram of exemplary instruction executing unit 150a according to some embodiments of the present disclosure.

FIG. 3A to FIG. 3C are schematic diagrams respectively showing exemplary acquisition of target data according to some embodiments of the present disclosure.

FIG. 4 is a flowchart of exemplary instruction executing method 400 according to some embodiments of the present disclosure.

FIG. 5A is a schematic diagram of exemplary instruction processing pipeline 900 according to some embodiments of the present disclosure.

FIG. 5B is a schematic diagram of an exemplary architecture of processor core 990 according to some embodiments of the present disclosure.

FIG. 6 is a schematic diagram of exemplary processor 1100 according to some embodiments of the present disclosure.

FIG. 7 is a schematic diagram of exemplary processor system 1200 according to some embodiments of the present disclosure.

FIG. 8 is a schematic diagram of exemplary system on chip (SoC) 1500 according to some embodiments of the present disclosure.

### DETAILED DESCRIPTION

To facilitate understanding of the solutions in the present disclosure, the technical solutions in some of the embodiments of the present disclosure will be described with reference to the accompanying drawings. It is appreciated that the described embodiments are merely a part of rather than all the embodiments of the present disclosure. Consistent with the present disclosure, other embodiments can be obtained without departing from the principles disclosed herein. Such embodiments shall also fall within the protection scope of the present disclosure.

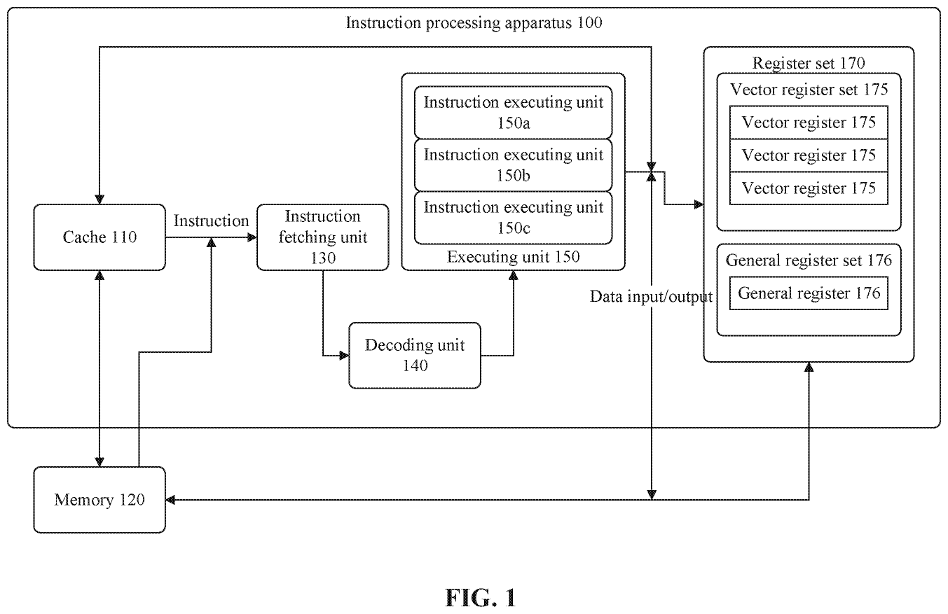

FIG. 1 is a schematic diagram of exemplary instruction processing apparatus 100 according to some embodiments of the present disclosure. In some embodiments, instruction processing apparatus 100 can be a processor, a processor core of a multi-core processor, or a processing element in an electronic system.

As shown in FIG. 1, instruction processing apparatus 100 includes instruction fetching unit 130. Instruction fetching unit 130 can obtain instructions (e.g., data load instructions) to be processed from cache 110, memory 120, or another source, and send them to decoding unit 140. The instructions fetched by instruction fetching unit 130 can include, but are not limited to, high-level machine instructions or macro instructions. Instruction processing apparatus 100 implements certain functions by executing these instructions.

Decoding unit 140 receives the instructions transmitted from instruction fetching unit 130 and decodes these instructions to generate low-level micro-operations, microcode entry points, micro-instructions, or other low-level instructions or control signals, which reflect the received instructions or are derived from the received instructions. The low-level instructions or control signals can implement operations of high-level instructions through low-level (e.g., circuit-level or hardware-level) operations. Decoding unit 140 can be implemented using various different mechanisms. Examples of suitable mechanisms include, but are not limited to, microcode, a lookup table, a hardware implementation, and a programmable logic array (PLA). The present disclosure is not limited to various mechanisms for implementing decoding unit 140, and any mechanism that can implement decoding unit 140 falls within the protection scope of the present disclosure.

Subsequently, these decoded instructions are sent to executing unit 150 and executed by executing unit 150. Executing unit 150 includes circuitry operable to execute instructions. When executing these instructions, executing unit 150 receives data input from register set 170, cache 110, or memory 120, and generates data to be outputted to them.

In some embodiments, register set 170 includes architectural registers that are also referred to as registers. Unless otherwise specified or apparently shown, phrases in this text such as the architectural register, the register set, and the register are used to denote registers that are visible to software or programmers (e.g., visible to software) or designated by macro instructions to identify operands. These registers are different from other non-architectural registers in a given micro-architecture (e.g., a temporary register, a reorder buffer, a retirement register).

According to some embodiments, register set 170 can include a set of vector registers 175, wherein each vector register 175 can be 512 bits, 256 bits, or 128 bits wide, or different vector widths can be used. Optionally, register set 170 can further include a set of general registers 176. General register 176 can be used when instruction executing unit 150 executes instructions.

Executing unit 150 can include a plurality of specific instruction executing units, e.g., 150a, 150b, . . . , and 150c. These instruction executing units are, for example, a vector operation unit, an arithmetic logic unit (ALU), an integer unit, a floating point unit, and a memory executing unit, and can execute different types of instructions separately. For example, instruction executing unit 150a is a memory executing unit and can execute instructions that access memory 120, especially address-unaligned data load instructions. Generally, the instructions that access memory 120 include a data storage instruction and a data load instruction. The data storage instruction is used to write data to cache 110 or memory 120. The data load instruction is used to read data from cache 110 or memory 120. In this example, data to be read by the data load instruction is referred to as target data hereinafter.

A source operand of the data load instruction includes an address operand related to a storage location of the target data (for example, the operand is a register, and the storage location of the target data can be calculated according to values stored in the register). A destination operand includes a data operand related to a storage location for storing the target data content (for example, another register or a storage location indicated by a value in the register). When processing the data load instruction, instruction executing unit 150a first calculates, according to the content of the source operand, the storage location of the target data to be accessed, and then reads the target data from the storage location and writes the target data to the register or storage space indicated by the data operand. Here, the storage location is indicated by an address.

It can be understood by those skilled in the art that the data load instruction includes an address-aligned instruction and an address-unaligned instruction. If an address of target data to be read is an integer multiple of a data length of the target data, the data load instruction is address aligned. If an address of target data is not an integer multiple of a data length of the target data, the data load instruction is address unaligned. It should be noted that, unless otherwise specified, the “address” mentioned throughout the text is a start address. For example, an address of target data is a start address of the target data.

There are some drawbacks in conventional processing methods. In the conventional processing methods, when executing an address-unaligned data load instruction, instruction executing unit 150a can split the instruction into a plurality of (usually two) accesses to the memory for processing, and then merge data acquired by the plurality of accesses to obtain target data. However, such processing can occupy a processor pipeline several times and the execution efficiency is low. Moreover, due to a plurality of accesses to the memory, not only the power consumption is very high, but also the processor performance is greatly reduced. The embodiments of the present disclosure address the above issues of low execution efficiency and processor performance loss when an address-unaligned data load instruction is executed.

According to some embodiments of the present disclosure, instruction executing unit 150a provides instruction executing method 400 to address the above issues.

Exemplary instruction processing apparatus 100 has been shown and described. It should be understood that instruction processing apparatus 100 can have different forms. For example, other embodiments of the instruction processing apparatus or a processor can have a plurality of cores, logical processors, or execution engines.

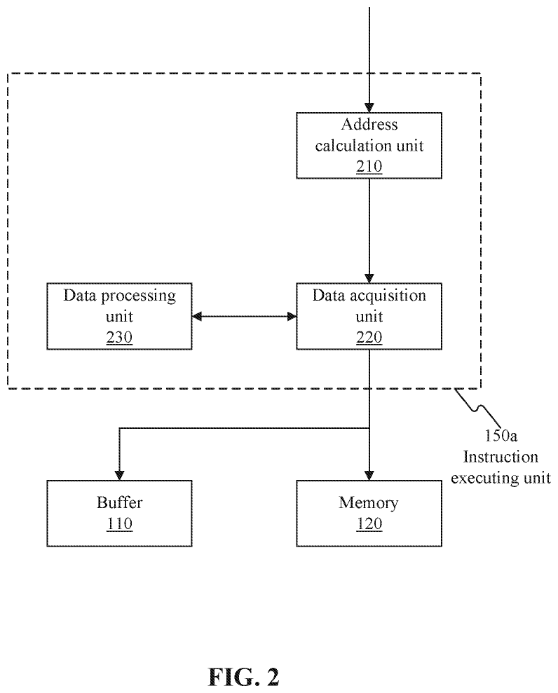

FIG. 2 is a schematic diagram of instruction executing unit 150a according to some embodiments of the present disclosure. It should be noted that, in FIG. 2, various components in instruction executing unit 150a are logically divided according to operations to be implemented in instruction executing unit 150a. These logical divisions are schematic and redivision can be made based on an actual physical layout and business needs without departing from the protection scope of the present disclosure. Instruction executing method 400 executed in instruction executing unit 150a can be completed by various components shown in FIG. 2. When the components shown in FIG. 2 are recombined and divided, corresponding method steps can be completed according to the logic carried by the new components without departing from the protection scope of the present disclosure.

As shown in FIG. 2, instruction executing unit 150a is respectively coupled to buffer 110 and memory 120 and includes address calculation unit 210. Address calculation unit 210 receives an address-unaligned data load instruction to be executed by instruction executing unit 150a and determines an address of the target data. Here, buffer 110 can be cache 110 shown in FIG. 1 or part of a storage space of cache 110.

A data load instruction can generally include an address and a data length of target data. In some embodiments, in the data load instruction, the address of the target data can be directly specified in a manner of immediate data, or it can be indicated that the address of the target data is stored in a register. In the latter case, address calculation unit 210 can acquire the address of the target data from the designated register.

In some embodiments, the address of the target data is an offset from a base address. Address calculation unit 210 can obtain the base address from, for example, a specific register, and obtain the offset from the data load instruction, thereby calculating the address of the target data.

Data acquisition unit 220 is coupled to address calculation unit 210, and can acquire the target data from buffer 110 or memory 120 based on the address and data length of the target data.

It can be understood by a person skilled in the art that memory 120 has a bit width, and the bit width of memory 120 indicates the number of bits of data that memory 120 can transmit in one clock cycle. The bit width of memory 120 can be, for example, 32 bits, 64 bits, and 128 bits. The bit width of memory 120 is not limited in the embodiments of the present disclosure.

As described above, some conventional processing methods have drawbacks. For example, assuming that target data to be acquired by a received address-unaligned data load instruction spans a bit width boundary of memory 120, according to the conventional processing methods, the target data can be divided into at least two parts of data based on the boundary, and the memory is accessed at least twice to obtain the at least two parts of data.

In comparison, according to some embodiments of the present disclosure, a part of data can be acquired from buffer 110, and the other part of data can be acquired from memory 120. In this way, the number of accesses to the memory is reduced.

Another comparison between the conventional processing methods and some embodiments of the present disclosure is described below. Assuming that target data to be acquired by a received address-unaligned data load instruction does not span a bit width boundary of memory 120, then according to conventional processing methods, memory 120 can be accessed once to acquire the target data.

However, according to some embodiments of the present disclosure, the target data can be directly acquired from buffer 110, thereby reducing the number of accesses to the memory.

The process of acquiring target data according to some embodiments of the present disclosure is described in detail below.

Data acquisition unit 220 can include circuitry to determine at least one of a first part of data or a second part of data of the target data based on an address interval of the target data and a bit width of memory 120. The first part of data or the second part of data is at least a part of data of the target data. The first part of data is data of a first plurality of bits in the target data, and the second part of data is data of a second plurality of bits in the target data.

In some embodiments, it can be determined based on an address interval of the target data and a bit width of the memory whether the target data spans a bit width boundary of memory 120. When the target data spans a bit width boundary, the target data is divided into the first part of data and the second part of data based on the spanned bit width boundary, and an address interval of the first part of data and an address interval of the second part of data are obtained. Here, the bit width boundary is an address aligned to the bit width of memory 120, that is, an address that is an integer multiple of the bit width of memory 120.

For example, it is assumed that the bit width of memory 120 is 8 bytes, and a certain data load instruction instructs to acquire target data with a length of 4 bytes and an address of 0x1006. Based on the data length and the address, it can be determined that an address interval of the target data is 0x1006˜0x1009, which spans a bit width boundary 0x1008 of memory 120. Therefore, target data 0x1006˜0x1009 can be divided into a first part of data 0x1006˜0x1007 and a second part of data 0x1008˜0x1009 based on the bit width boundary 0x1008.

If the target data does not span a bit width boundary of memory 120, there is no need to perform division, and the first part of data can be regarded as the target data.

It should be noted that the target data can span one or more bit width boundaries of memory 120, and accordingly, the target data can be divided into one or more first parts of data and one or more second parts of data. For example, assuming that the bit width of memory 120 is 4 bytes, a certain data load instruction instructs to acquire target data with a length of 8 bytes and an address of 0x1002. Based on the data length and the address, it can be determined that an address interval of the target data is 0x1002˜0x1009, which spans bit width boundaries 0x1004 and 0x1008 of memory 120. Therefore, target data 0x1002˜0x1009 can be divided into a first part of data 0x1002˜0x1003, one second part of data 0x1004˜0x1007, and another second part of data 0x1008˜0x1009 based on the bit width boundaries 0x1004 and 0x1008.

Data acquisition unit 220 can include circuitry to acquire each first part of data of the target data from buffer 110. In some embodiments, buffer 110 stores at least one piece of buffered data, and the buffered data is at least a part of the data acquired by the previous access to memory 120. Data acquisition unit 220 can include circuitry to search the at least one piece of buffered data stored in buffer 110 for the piece of buffered data including the first part of data of the target data and extract the first part of data therefrom.

Specifically, data acquisition unit 220 can include circuitry to perform a search based on an address interval of the first part of data and an address interval of the buffered data. For example, it can be determined whether the address interval of the buffered data includes the address interval of the first part of data. If the address interval of the buffered data includes the address interval of the first part of data, the corresponding piece of buffered data includes the first part of data; otherwise, the corresponding piece of buffered data does not include the first part of data.

The address interval of the first part of data can be obtained when the first part of data or the second part of data is determined. The address interval of the buffered data or the address and data length corresponding to the piece of buffered data can be stored in buffer 110 in association with the piece of buffered data. In the latter case, the address interval of the buffered data can be determined based on the address and data length corresponding to the buffered data.

In some other embodiments, if data acquisition unit 220 cannot obtain the first part of data from buffer 110, that is, the buffered data including the first part of data cannot be found by searching, the first part of data still can be acquired from memory 120.

Data acquisition unit 220 can include circuitry to acquire each second part of data of the target data from memory 120. The process of acquiring each first part of data if necessary or each second part of data from memory 120 is similar, and the description is made below by taking acquisition of one second part of data as an example.

Data acquisition unit 220 include circuitry to accesses memory 120 based on an address of the second part of data and a bit width of memory 120 and extracts the second part of data from the data acquired by the access. Here, the address of the data obtained by the access is aligned to the data length and includes at least the second part of data.

Specifically, a data length of the data to be acquired by the access can be specified based on a bit width of the memory. For example, the data length is specified as the bit width of the memory, or another suitable length that is not less than the data length of the second part of data and not greater than the bit width of the memory.

Further, an address of the data to be acquired by the access can be specified based on the address of the second part of data. For example, when the address of the second part of data is aligned to the specified data length, the address of the second part of data is specified as the address of the data to be acquired by the access. In another example, when the address of the second part of data is unaligned to the specified data length, an address before the address of the second part of data and aligned to the specified data length is specified as the address of the data to be acquired by the access.

According to some embodiments of the present disclosure, after accessing the memory and acquiring data including the first part of data or the second part of data, data processing unit 230 can also include circuitry to store at least a part of the data acquired by the access in buffer 110 as buffered data.

In some embodiments, at least a part of the data acquired by the access can be used to replace a piece of buffered data including the first part of data or the second part of data; or, at least a part of the data acquired by the access can be stored as a new piece of buffered data. At least a part of the data acquired by the access stored in the buffer can be all data, can be a part other than the first part of data or the second part of data, or can be another part.

Data processing unit 230 is coupled to data acquisition unit 220, and can include circuitry to obtain, at least based on the acquired first part of data, target data as an execution result of the foregoing data load instruction.

In an example that the target data does not span a bit width boundary although being address-unaligned, the first part of data is the target data (the second part of data does not exist at this moment), and the first part of data acquired from buffer 110 can be directly used as an execution result of the data load instruction. In this way, target data can be obtained without accessing the memory, which reduces the number of accesses to the memory.

In some embodiments, the first part of data is only a part of data of the target data, and data acquisition unit 220 can include circuitry to acquire the second part of data of the target data from memory 120. After data acquisition unit 220 can include circuitry to acquire the first part of data and the second part of data, data processing unit 230 can include circuitry to merge the first part of data and the second part of data to obtain the target data. As described above, in the conventional processing methods, the target data can only be obtained originally by accessing the memory at least twice. In comparison, with the instruction executing method according to the embodiment of the present disclosure, the target data can be obtained by accessing the memory only once, thus reducing the number of accesses to the memory.

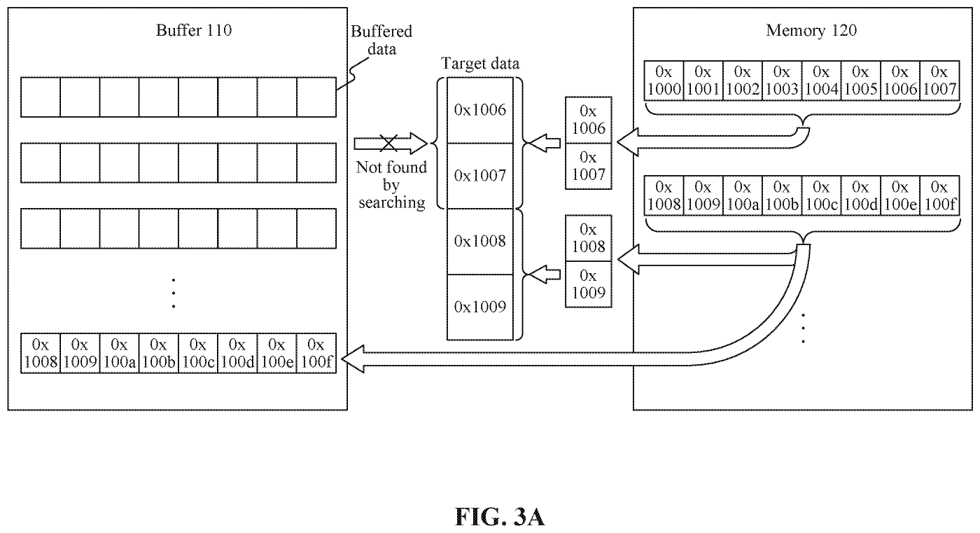

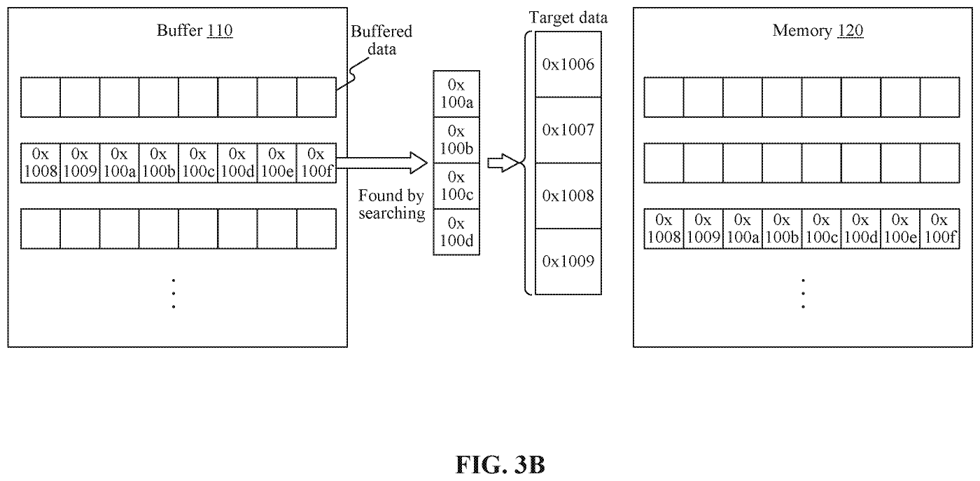

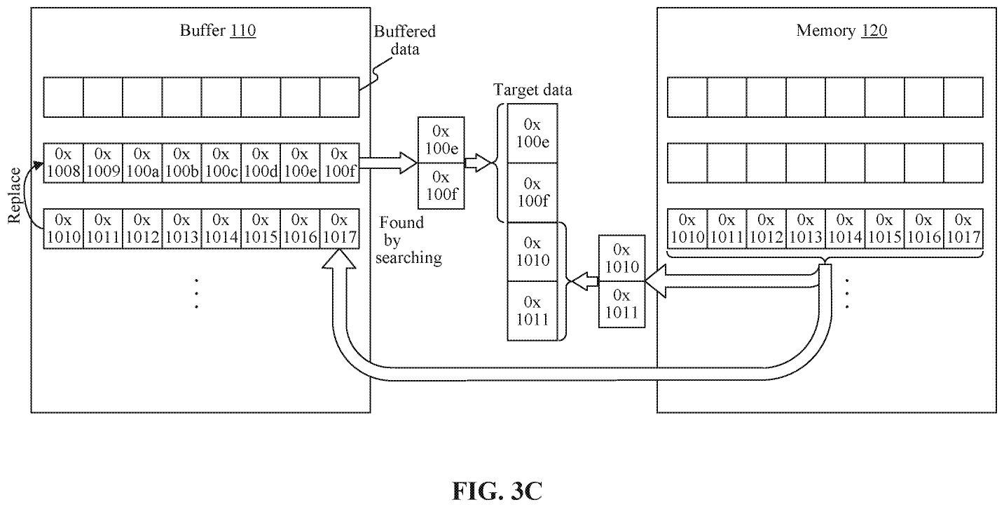

The process of acquiring target data according to some embodiments of the present disclosure is further described below with reference to FIG. 3.

FIG. 3A to FIG. 3C are schematic diagrams respectively showing exemplary acquisition of target data according to some embodiments of the present disclosure. Assuming that a bit width of the memory is 8 bytes, each access to the memory specifies a data length as the bit width of the memory.

First, as shown in FIG. 3A, a first address-unaligned data load instruction is received, which instructs to acquire target data with an address of 0x1006 and a data length of 4 bytes. A corresponding address interval of the target data is 0x1006˜0x1009, which spans a bit width boundary 0x1008 of the memory, so the target data can be divided into data 0x1006˜0x1007 and data 0x1008˜0x1009. For data 0x1006˜0x1007, since no buffered data including data 0x1006˜0x1007 can be found by searching in buffer 110, it can be obtained by accessing memory 120. For data 0x1008˜0x1009, the memory is accessed to obtain data 0x1008˜0x100f, from which data 0x1008˜0x1009 is extracted. At the same time, the content and address interval of data 0x1008˜0x100f can be stored in buffer 110 as a new piece of buffered data.

Then, as shown in FIG. 3B, a second address-unaligned data load instruction is received, which instructs to acquire target data with an address of 0x100a and a data length of 4 bytes. A corresponding address interval of the target data is 0x100a˜0x100d. Although the data is address-unaligned, the data does not span the bit width boundary. Therefore, buffered data including data 0x100a˜0x100d is searched for in buffer 110. After buffered data 0x1008˜0x100f is found by searching, data 0x100a˜0x100d is extracted from the buffered data. Since memory 120 is not accessed, buffer 110 is not updated.

Then, as shown in FIG. 3C, a third address-unaligned data load instruction is received, which instructs to acquire target data with an address of 0x100e and a data length of 4 bytes. A corresponding address interval of the target data is 0x100e˜0x1011, which spans a bit width boundary 0x100f of the memory, so the target data can be divided into data 0x100e˜0x100f and data 0x1010˜0x1011. For data 0x100e˜0x100f, buffered data including data 0x100e˜0x100f is searched for in buffer 110, and after buffered data 0x1008˜0x100f is found by searching, data 0x100e˜0x100f is extracted from the buffered data. For data 0x1010˜0x1011, the memory is accessed to obtain data 0x1010˜0x1017, from which data 0x1010˜0x1011 is extracted. The content and the address interval of data 0x1010˜0x1017 can be used to replace buffered data 0x1008˜0x100f and are stored in buffer 110. Subsequently received address-unaligned data load instructions are processed similarly.

It can be known from the foregoing that the instruction executing method according to some embodiments of the present disclosure can effectively reduce the number of accesses to a memory when address-unaligned data load instructions are processed, especially in a scenario of consecutive addresses shown in FIG. 3A to FIG. 3C. It should be noted that although the addresses in FIG. 3A to FIG. 3C are incremented, the addresses can also be decremented.

It should also be noted that although the bit width of the memory is described as 8 bytes (64 bits) in the above example, the bit width of the memory can also be other values, such as 32 bits, 128 bits, and 256 bits. The bit width of the memory is not limited in the present disclosure, and any bit width is within the protection scope of the present disclosure.

In addition, it should also be noted that although target data (the first data load instruction and the second data load instruction) are only divided into two parts of data in the above example, the target data can also be divided into more parts of data, for example, three parts of data and four parts of data. Some parts of the data can be extracted from corresponding buffered data, and some parts of the data can be extracted respectively from corresponding data obtained by accessing the memory several times.

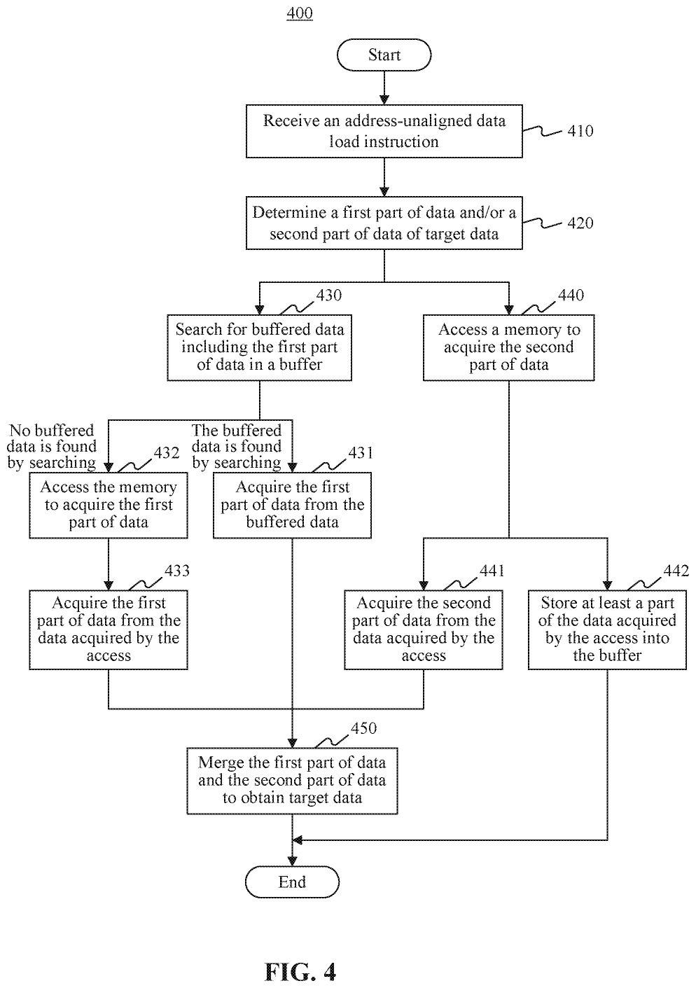

FIG. 4 is a flowchart of exemplary instruction executing method 400 according to some embodiments of the present disclosure. Instruction executing method 400 can be adapted to be executed in instruction processing apparatus 100 shown in FIG. 1, especially instruction executing unit 150a shown in FIG. 2.

Instruction executing method 400 starts from step 410. In step 410, an address-unaligned data load instruction is received, the data load instruction instructing to read target data from memory 120. The address-unaligned data load instruction refers to a data load instruction in which an address of the target data is not an integer multiple of a data length of the target data.

Then, in step 420, at least one of a first part of data or a second part of data of the target data is determined, at least one of the first part of data or the second part of data being at least a part of data of the target data. The first part of data is data of a first plurality of bits in the target data, and the second part of data is data of a second plurality of bits in the target data.

In some embodiments, the determination can be made based on an address interval of the target data and a bit width of memory 120. For example, a bit width boundary of memory 120 spanned by the target data is determined based on an address interval of the target data and a bit width of the memory. Based on the spanned bit width boundary, the target data is divided into the first part of data and the second part of data. If the target data does not span the bit width boundary, it can be considered that the target data is the first part of data.

The first part of data of the target data can be obtained from buffer 110, and buffer 110 stores at least one piece of buffered data. According to some embodiments of the present disclosure, in step 430, buffered data including the first part of data is searched based on an address interval of the first part of data and an address interval of the buffered data. If the buffered data including the first part of data is found by searching, in step 431, the first part of data is acquired from the found buffered data. If the buffered data cannot be found by searching, the first part of data can be acquired from memory 120, that is, in step 432, memory 120 is accessed based on an address of the first part of data and a bit width of memory 120 to obtain data including the first part of data. In step 433, the first part of data is acquired from the data acquired by the access.

A data length of the data to be acquired by the access can be specified based on the bit width of memory 120, an address of the data to be acquired by the access can be specified based on the address of the first part of data, and the address is aligned to the data length of the data to be acquired by the access.

In some embodiments, after the first part of data is obtained, target data can be obtained at least based on the first part of data to serve as an execution result of the data load instruction. For example, if the target data does not span the bit width boundary, the first part of data is the target data.

In most cases, after at least one of the first part of data or the second part of data of the target data is determined, the second part of data can be acquired from memory 120. Specifically, in step 440, memory 120 is accessed based on an address of the second part of data and the bit width of memory 120 to obtain data including the second part of data. In step 441, the second part of data is acquired from the data acquired by the access. In addition, in step 442, at least a part of the data acquired by the access can also be stored in buffer 110 as buffered data.

A data length of the data to be acquired by the access can be specified based on the bit width of memory 120, an address of the data to be acquired by the access can be specified based on the address of the second part of data, and the address is aligned to the data length of the data to be acquired by the access.

After the first part of data and the second part of data are obtained, in step 450, the first part of data and the second part of data are merged to obtain the target data as an execution result of the data load instruction.

In addition, it should be noted that the second part of data can include a plurality of second parts of data. Then, for each second part of data in the target data, the memory can be accessed once based on an address of the second part of data and the bit width of the memory. The data acquired by this access includes the second part of data.

Correspondingly, the first part of data can also include a plurality of first parts of data. Then, for each first part of data in the target data, it is necessary to search for buffered data including the first part of data based on an address interval of the first part of data and an address interval of the buffered data.

For the detailed processing logic and implementation process of various steps in instruction executing method 400, reference can be made to the foregoing related description of instruction processing apparatus 100 and instruction executing unit 150a made with reference to FIG. 1 to FIG. 3C.

Using the instruction executing method according to some embodiments of the present disclosure, by acquiring at least a part of data of target data from a buffer when address-unaligned data load instructions are processed (especially instructions with consecutive addresses), the number of accesses to a memory can be effectively reduced, thereby significantly improving the instruction execution efficiency and the processor performance, and reducing the power consumption.

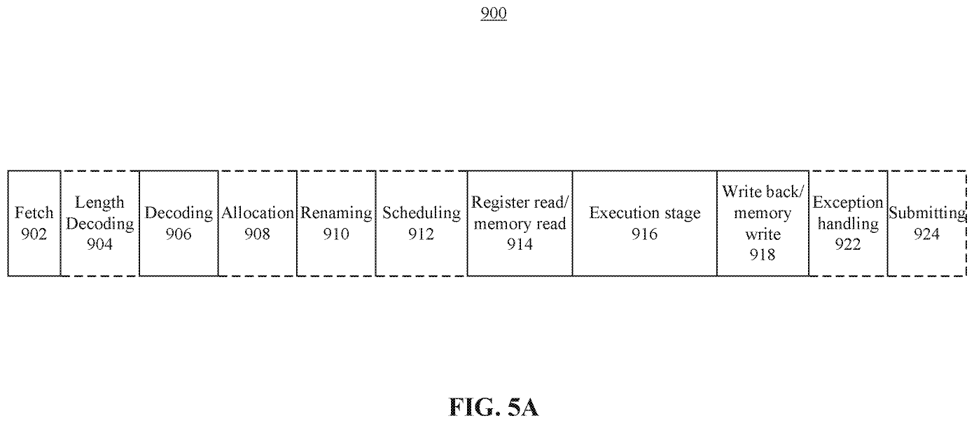

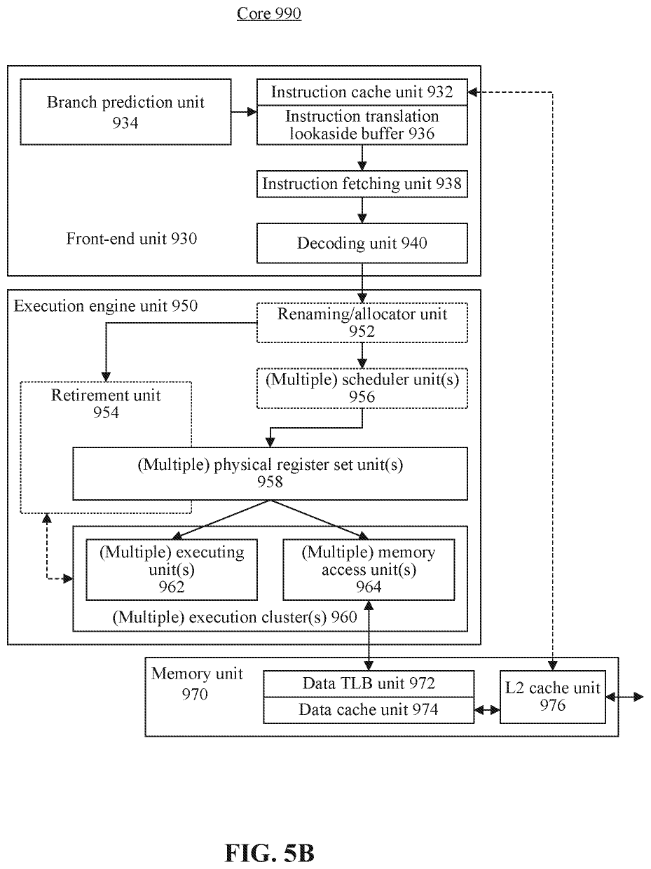

As described above, the instruction processing apparatus according to some embodiments of the present disclosure can be implemented as a processor core, and the instruction executing method can be executed in the processor core. The processor core can be implemented in different processors in different manners. For example, the processor core can be implemented as a general ordered core for general computing, a high-performance general unordered core for general computing, and a dedicated core for graphics or scientific throughput computing. The processor can be implemented as a Central Processing Unit (CPU) or co-processor, where the CPU can include one or more general ordered cores or one or more general unordered cores, and the coprocessor can include one or more dedicated cores. Such a combination of different processors can lead to different computer system architectures. In a computer system architecture, the coprocessor is located on a chip separate from the CPU. In another computer system architecture, the coprocessor is located in the same package as the CPU but on a separate die. In yet another computer system architecture, the coprocessor is located on the same die as the CPU (the coprocessor is sometimes referred to as dedicated logic such as integrated graphics or scientific throughput logic, or referred to as a dedicated core). In yet another computer system architecture referred to as a system on chip, the described CPU (sometimes referred to as an application core or application processor), the coprocessor described above, and additional functions can be included on the same die. Exemplary core architecture, processor, and computer architecture are described subsequently with reference to FIG. 5A to FIG. 8.

FIG. 5A is a schematic diagram of an exemplary instruction processing pipeline according to some embodiments of the present disclosure, wherein the pipeline includes an ordered pipeline and an unordered issue/execution pipeline. FIG. 5B is a schematic diagram of an exemplary processor core architecture according to some embodiments of the present disclosure, which includes an ordered architecture core and an unordered issue/execution architecture core related to register renaming In FIG. 5A and FIG. 5B, the ordered pipeline and ordered core are shown in solid boxes, while the optional additional items in dotted boxes show the unordered issue/execution pipeline and core.

As shown in FIG. 5A, processor pipeline 900 includes fetch stage 902, length decoding stage 904, decoding stage 906, allocation stage 908, renaming stage 910, scheduling (also referred to as dispatching or issuing) stage 912, register read/memory read stage 914, execution stage 916, write back/memory write stage 918, exception handling stage 922, and submitting stage 924.

As shown in FIG. 5B, processor core 990 includes execution engine unit 950 and front-end unit 930 coupled to execution engine unit 950. Both execution engine unit 950 and front-end unit 930 are coupled to memory unit 970. Core 990 can be a Reduced Instruction Set Computer (RISC) core, a Complex Instruction Set Computer (CISC) core, a Very Long Instruction Word (VLIW) core, or a hybrid or alternative core type. As yet another option, core 990 can be a dedicated core, such as, a network or communication core, a compression engine, a coprocessor core, a general-purpose computing graphics processor unit (GPGPU) core, and a graphics core (GPU).

Front-end unit 930 includes branch prediction unit 934, instruction cache unit 932 coupled to branch prediction unit 934, instruction translation lookaside buffer (TLB) 936 coupled to instruction cache unit 932, instruction fetching unit 938 coupled to instruction translation lookaside buffer 936, and decoding unit 940 coupled to instruction fetching unit 938. Decoding unit (or decoder) 940 can decode instructions and generate one or more micro-operations, microcode entry points, microinstructions, other instructions, or other control signals decoded from the original instructions or otherwise reflecting the original instructions or derived from the original instructions as output. Decoding unit 940 can be implemented using various different mechanisms, including, but are not limited to, a lookup table, a hardware implementation, a programmable logic array (PLA), a microcode read-only memory (ROM), and so on. In some embodiments, core 990 includes a microcode ROM or another medium that stores microcode of certain macro instructions (e.g., in decoding unit 940 or otherwise in front-end unit 930). Decoding unit 940 is coupled to renaming/allocator unit 952 in execution engine unit 950.

Execution engine unit 950 includes renaming/allocator unit 952. Renaming/allocator unit 952 is coupled to retirement unit 954 and one or more scheduler units 956. Scheduler units 956 represent any number of different schedulers, including reservation stations, central instruction windows, and so on. Scheduler units 956 are coupled to various physical register set units 958. Each physical register set unit 958 represents one or more physical register sets. Different physical register sets store one or more different data types, for example, scalar integer, scalar floating point, packed integer, packed floating point, vector integer, vector floating point, and status (such as an instruction pointer as an address of a next instruction to be executed). In some embodiments, physical register set unit 958 includes a vector register unit, a write mask register unit, and a scalar register unit. These register units can provide architectural vector registers, vector mask registers, and general registers. Physical register set unit 958 is covered by retirement unit 954 to show various manners that can be used to implement register renaming and unordered execution (for example, using reordering buffers and retirement register sets; using future files, historical buffers, and retirement register sets; and using register maps and register pools). Retirement unit 954 and physical register set unit 958 are coupled to execution cluster 960.

Execution cluster 960 includes one or more executing units 962 and one or more memory access units 964. Executing unit 962 can perform various operations (for example, shift, addition, subtraction, and multiplication) and perform operations on various types of data (for example, scalar floating point, packed integer, packed floating point, vector integer, and vector floating point). Although some embodiments can include multiple executing units dedicated to specific functions or function sets, some other embodiments can include only one executing unit or multiple executing units that all perform all functions. In some embodiments, since separate pipelines (e.g., scalar integer pipelines, scalar floating point/packed integer/packed floating point/vector integer/vector floating point pipelines, or memory access pipelines each having its own scheduler unit, physical register set unit, or execution cluster) are created for certain types of data/operations, there can be more than one scheduler unit 956, physical register set unit 958, and execution cluster 960. It should also be understood that where separate pipelines are used, one or more of these pipelines can be issued/executed out of order, and the remaining pipelines can be issued/executed in order.

Memory access unit 964 is coupled to memory unit 970, which includes data TLB unit 972, data cache unit 974 coupled to data TLB unit 972, and level-2 (L2) cache unit 976 coupled to data cache unit 974. In some embodiments, memory access unit 964 can include a load unit, a storage address unit, and a storage data unit, each of which is coupled to data TLB unit 972 in memory unit 970. Instruction cache unit 932 can be further coupled to level-2 (L2) cache unit 976 in memory unit 970. L2 cache unit 976 is coupled to one or more caches of other levels and is eventually coupled to a main memory.

As an example, the core architecture described above with reference to FIG. 5B can implement pipeline 900 described above with reference to FIG. 5A in the following manner: instruction fetch unit 938 performs fetch and length decoding stages 902 and 904; decoding unit 940 performs decoding stage 906;

renaming/allocator unit 952 performs distribution stage 908 and renaming stage 910; scheduler unit 956 performs scheduling stage 912;

physical register set unit 958 and memory unit 970 perform register read/memory read stage 914; execution cluster 960 performs execution stage 916;

memory unit 970 and physical register set unit 958 perform write back/memory write stage 918;

each unit can involve exception handling stage 922; and

retirement unit 954 and physical register set unit 958 perform submitting stage 924.

Processor core 990 can support one or more instruction sets (for example, an x86 instruction set with certain extensions added with relatively new versions; an MIPS instruction set of the MIPS Technology Corporation; an ARM instruction set with optional additional extensions such as NEON of the ARM Holding), which include the instructions described herein. It should be understood that the core can support multi-threading (e.g., performing a collection of two or more parallel operations or threads), and that the multi-threading can be accomplished in various manners, including time-division multi-threading, synchronization multi-threading in which a single physical core provides a logical core for each thread of the threads in the synchronization multi-threading of physical cores, or a combination thereof (for example, time-division fetching and decoding, and subsequent synchronization multi-threading using, for example, the hyper-threading technology).

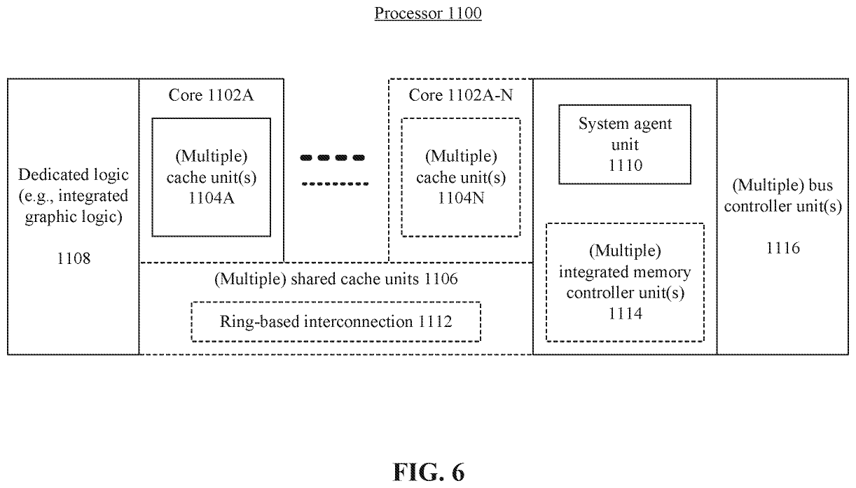

FIG. 6 is a schematic diagram of processor 1100 according to some embodiments of the present disclosure. As shown by the solid line box in FIG. 6, according to some embodiments, processor 1110 includes single core 1102A, system agent unit 1110, and bus controller unit 1116. As shown by the dotted box in FIG. 6, according to another implementation of the present disclosure, processor 1100 can further include a plurality of cores 1102A-N, integrated memory controller unit 1114 in system agent unit 1110, and dedicated logic 1108.

According to some embodiments, processor 1100 can be implemented as a central processing unit (CPU), wherein dedicated logic 1108 is the integrated graphics or scientific throughput logic (which can include one or more cores), and cores 1102A-N include one or more general cores (e.g., a general ordered core, a general unordered core, and a combination of both). According to another implementation, processor 1100 can be implemented as a coprocessor, wherein cores 1102A-N are a plurality of dedicated cores for graphics or scientific throughput. According to yet another implementation, processor 1100 can be implemented as a coprocessor, wherein cores 1102A-N are a plurality of general ordered cores. Therefore, processor 1100 can be a general processor, a coprocessor, or a dedicated processor, such as, for example, a network or communication processor, a compression engine, a graphics processor, a general-purpose graphics processing unit (GPGPU), a high-throughput many integrated core (MIC) coprocessor (including 30 or more cores), or an embedded processor. The processor can be implemented on one or more chips. Processor 1100 can be part of one or more substrates, or can be implemented on one or more substrates by using any of a plurality of processing techniques such as, for example, BiCMOS, CMOS, or NMOS.

A memory hierarchical structure includes one or more levels of cache within each core, one or more shared cache units 1106, and an external memory (not shown) coupled to integrated memory controller unit 1114. Shared cache unit 1106 can include one or more intermediate level caches, such as level 2 (L2), level 3 (L3), level 4 (L4) or other levels of caches, last level cache (LLC), or combinations thereof. Although in some embodiments, ring-based interconnection unit 1112 interconnects integrated graphics logic 1108, shared cache unit 1106, and system agent unit 1110/integrated memory controller unit 1114, the present disclosure is not limited thereto, and these units can be interconnected using any number of well-known techniques.

System agent 1110 includes those components that coordinate and operate cores 1102A-N. System agent unit 1110 can include, for example, a power control unit (PCU) and a display unit. The PCU can include logic and components that can adjust power states of cores 1102A-N and integrated graphics logic 1108. The display unit is configured to drive one or more externally connected displays.

Cores 1102A-N can have the core architecture described above with reference to FIG. 1 and FIG. 5B and can be homogeneous or heterogeneous in terms of architectural instruction set. That is, two or more of cores 1102A-N can be able to execute the same instruction set, while other cores can be able to execute only a subset of the instruction set or a different instruction set.

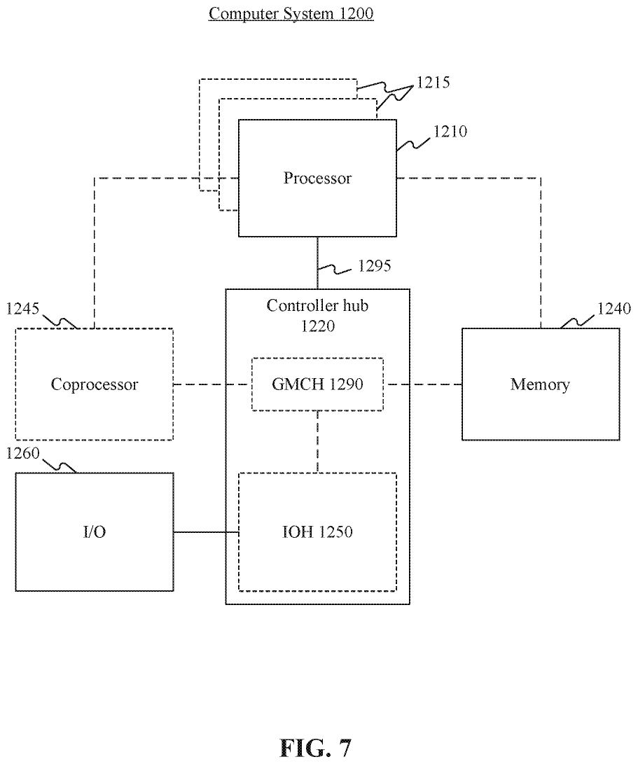

FIG. 7 is a schematic diagram of exemplary computer system 1200 according to some embodiments of the present disclosure. Computer system 1200 shown in FIG. 7 can be applied to a laptop device, a desktop computer, a handheld PC, a personal digital assistant, an engineering workstation, a server, a network device, a network hub, a switch, an embedded processor, a digital signal processor (DSP), a graphic device, a video game device, a set-top box, a microcontroller, a cellular phone, a portable media player, a handheld device, and various other electronic devices. The present disclosure is not limited thereto, and all systems that can incorporate the processor or other execution logic disclosed in this specification fall within the protection scope of the present disclosure.

As shown in FIG. 7, system 1200 can include one or more processors 1210, 1215. These processors are coupled to controller hub 1220. In some embodiments, controller hub 1220 includes graphics memory controller hub (GMCH) 1290 and input/output hub (IOH) 1250 (which can be located on separate chips). GMCH 1290 includes a memory controller and a graphics controller coupled to memory 1240 and coprocessor 1245. IOH 1250 couples input/output (I/O) device 1260 to GMCH 1290. Alternatively, the memory controller and the graphics controller are integrated in the processor, so that memory 1240 and coprocessor 1245 are directly coupled to processor 1210, and controller hub 1220 includes only IOH 1250.

The optional property of additional processor 1215 is shown in dashed lines in FIG. 7. Each processor 1210, 1215 can include one or more of the processing cores described herein, and can be a certain version of processor 1100 shown in FIG. 6.

Memory 1240 can be, for example, a dynamic random access memory (DRAM), a phase change memory (PCM), or a combination of both. For at least some embodiments, controller hub 1220 is connected via a multi-drop bus such as a front side bus (FSB), a point-to-point interface such as quick path interconnect (QPI), or a similar connection 1295 to communicate with processors 1210 and 1215.

In some embodiments, coprocessor 1245 is a dedicated processor, such as, for example, a high-throughput MIC processor, a network or communication processor, a compression engine, a graphics processor, a GPGPU, or an embedded processor. In some embodiments, controller hub 1220 can include an integrated graphics accelerator.

In some embodiments, processor 1210 executes instructions that control data processing operations of general types. Embedded in these instructions can be coprocessor instructions. Processor 1210 identifies these coprocessor instructions as having the type that should be executed by the attached coprocessor 1245. Therefore, processor 1210 issues these coprocessor instructions (or control signals representing coprocessor instructions) to coprocessor 1245 on the coprocessor bus or another interconnect. Coprocessor 1245 accepts and executes the received coprocessor instructions.

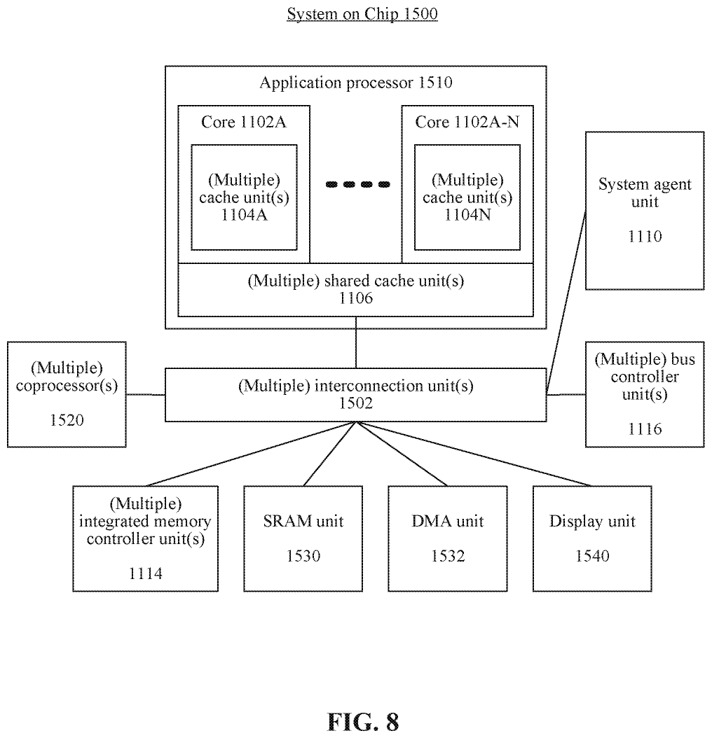

FIG. 8 is a schematic diagram of exemplary System on Chip (SoC) 1500 according to some embodiments of the present disclosure. The System on Chip shown in FIG. 8 includes processor 1100 shown in FIG. 6, and therefore, the components similar to those in FIG. 6 have the same reference numerals. As shown in FIG. 8, interconnection unit 1502 is coupled to application processor 1510, system agent unit 1110, bus controller unit 1116, integrated memory controller unit 1114, one or more coprocessors 1520, static random access memory (SRAM) unit 1530, direct memory access (DMA) unit 1532, and display unit 1540 configured to be coupled to one or more external displays. Application processor 1510 includes a set of one or more cores 1102A-N and shared cache unit 1106. Coprocessor 1520 includes integrated graphics logic, an image processor, an audio processor, and a video processor. In some embodiments, coprocessor 1520 includes a dedicated processor, such as, for example, a network or communication processor, a compression engine, a GPGPU, a high-throughput MIC processor, or an embedded processor.

In addition, the System on Chip described above can be included in an intelligent device in order to realize corresponding functions in the intelligent device, including but not limited to executing related control programs, performing data analysis, operation and processing, network communication, and controlling peripheral devices in the intelligent device.

Such intelligent devices include specialized intelligent devices, such as mobile terminals and personal digital terminals. These devices include one or more systems on chip according to the present disclosure to perform data processing or control peripheral devices in the device.

Such intelligent devices also include dedicated devices constructed to achieve specific functions, such as intelligent speakers and intelligent display devices. These devices include the system on chip according to the present disclosure to control the speaker and the display device, thereby giving the speaker and the display device additional functions such as communication, perception, and data processing.

Such intelligent devices also include various IoT and AIoT devices. These devices include the System on Chip according to the present disclosure for data processing, e.g., performing AI operations, data communication and transmission, thereby achieving a denser and more intelligent device distribution.

Such intelligent devices can also be used in vehicles, for example, they can be implemented as in-vehicle devices or can be embedded in vehicles to provide data processing capabilities for intelligent driving of the vehicles.

Such intelligent devices can also be used in the home and entertainment fields, for example, they can be implemented as intelligent speakers, intelligent air conditioners, intelligent refrigerators, intelligent display devices, and so on. These devices include the System on Chip according to the present disclosure for data processing and peripheral control, thereby providing smart home and entertainment devices.

In addition, such intelligent devices can also be used in industrial fields, for example, they can be implemented as industrial control devices, sensing devices, IoT devices, AIoT devices, and braking devices. These devices include the System on Chip according to the present disclosure for data processing and peripheral control, thereby providing smart industrial equipment.

The above description of the intelligent devices is only schematic, the intelligent device according to the present disclosure is not limited thereto, and all intelligent devices that can perform data processing using the system on chip according to the present disclosure fall within the protection scope of the present disclosure.

As used herein, unless specifically stated otherwise, the term “or” encompasses all possible combinations, except where infeasible. For example, if it is stated that a device may include A or B, then, unless specifically stated otherwise or infeasible, the device may include A, or B, or A and B. As a second example, if it is stated that a device may include A, B, or C, then, unless specifically stated otherwise or infeasible, the device may include A, or B, or C, or A and B, or A and C, or B and C, or A and B and C.

It is appreciated that the above described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. One of ordinary skill in the art will also understand that multiple ones of the above described modules/units may be combined as one module/unit, and each of the above described modules/units may be further divided into a plurality of sub-modules/sub-units.

Based on the several embodiments provided in the present disclosure, it should be appreciated that the disclosed technical contents may be implemented in another manner. The described apparatus, system, and method embodiments are only exemplary. For example, division of units or modules are merely exemplary division based on the logical functions. Division in another manner may exist in actual implementation. Further, a plurality of units or components may be combined or integrated into another system. Some features or components may be omitted or modified in some embodiments. In addition, the mutual coupling or direct coupling or communication connections displayed or discussed may be implemented by using some interfaces. The indirect coupling or communication connections between the units or modules may be implemented electrically or in another form.

Further, the units described as separate parts may or may not be physically separate. Parts displayed as units may or may not be physical units. They may be located in a same location or may be distributed on a plurality of network units. Some or all of the units may be selected according to actual needs to achieve the objectives of the solutions of the embodiments. In addition, functional units in the embodiments of the present disclosure may be integrated into one processing unit. Each of the units may exist alone physically, or two or more units can be integrated into one unit. The integrated unit may be implemented in a form of hardware or may be implemented in a form of a software functional unit.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

It is appreciated that terms “first,” “second,” and so on used in the specification, claims, and the drawings of the present disclosure are used to distinguish similar objects. These terms do not necessarily describe a particular order or sequence. The objects described using these terms can be interchanged in appropriate circumstances. That is, the procedures described in the exemplary embodiments of the present disclosure could be implemented in an order other than those shown or described herein. In addition, terms such as “comprise,” “include,” and “have” as well as their variations are intended to cover non-exclusive inclusion. For example, a process, method, system, product, or device including a series of steps or units are not necessarily limited to the steps or units clearly listed. In some embodiments, they may include other steps or units that are not clearly listed or inherent to the process, method, product, or device.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

It is appreciated that the above descriptions are only exemplary embodiments provided in the present disclosure. Consistent with the present disclosure, those of ordinary skill in the art may incorporate variations and modifications in actual implementation, without departing from the principles of the present disclosure. Such variations and modifications shall all fall within the protection scope of the present disclosure.

What is claimed is:

1. An instruction executing method, comprising:
receiving an address-unaligned data load instruction, the data load instruction instructing to read target data from a memory;
acquiring a first part of data of the target data from a buffer, the first part of data being data of a first plurality of bits in the target data;
acquiring a second part of data of the target data from the memory, the second part of data being data of a second plurality of bits in the target data; and
merging the first part of data and the second part of data to obtain the target data.

2. The method of claim 1, wherein the buffer stores at least one piece of buffered data, and acquiring the first part of data of the target data from the buffer comprises:
searching for, based on an address interval of the first part of data and an address interval of the buffered data, buffered data that comprises the first part of data of the target data.

3. The method of claim 1, wherein acquiring the second part of data of the target data from the memory comprises:
accessing the memory based on an address of the second part of data and a bit width of the memory to acquire data, the acquired data comprising the second part of data.

4. The method of claim 3, wherein accessing the memory based on an address of the second part of data and a bit width of the memory comprises:
specifying, based on the bit width of the memory, a data length of data to be acquired by the access; and
specifying, based on the address of the second part of data, an address of the data to be acquired by the access, the address being aligned to the data length.

5. The method of claim 3, wherein after accessing the memory, the method further comprises:
storing at least a part of the acquired data into the buffer as buffered data.

6. The method of claim 1, further comprising:
determining, based on an address interval of the target data and a bit width of the memory, at least one of the first part of data or the second part of data of the target data.

7. The method of claim 6, wherein determining, based on the address interval of the target data and a bit width of the memory, at least one of the first part of data or the second part of data of the target data comprises:
determining, based on the address interval of the target data and the bit width of the memory, a bit width boundary spanned by the target data; and
dividing, based on the spanned bit width boundary, the target data into the first part of data and the second part of data.

8. The method of claim 1, wherein an address of the target data in the address-unaligned data load instruction is not equal to an integer multiple of a data length of the target data.

9. The method of claim 1, wherein the second part of data comprises a plurality of second parts of data, and acquiring the second part of data of the target data from the memory comprises:
for each second part of data of the target data, accessing the memory based on an address of each second part of data and a bit width of the memory to obtain data, the obtained data comprising the second part of data.

10. The method of claim 1, wherein the first part of data comprises a plurality of first parts of data, the buffer stores at least one piece of buffered data, and acquiring the first part of data of the target data from the buffer comprises:
for each first part of data of the target data, searching for, based on an address interval of the first part of data and an address interval of the buffered data, buffered data that comprises the first part of data.

11. A processing apparatus communicatively coupled to a memory, the processing apparatus comprising:
a buffer configured to store buffered data;
an instruction executing unit having circuitry configured to execute an address-unaligned data load instruction, wherein the data load instruction is used to read target data from the memory and the instruction executing unit is coupled to the buffer and the memory;
a data acquisition unit having circuitry configured to acquire a first part of data of the target data from the buffer, the first part of data being data of a first plurality of bits in the target data, and to acquire a second part of data of the target data, the second part of data being data of a second plurality of bits in the target data; and
a data processing unit having circuitry configured to merge the first part of data and the second part of data to obtain the target data.

12. The processing apparatus of claim 11, wherein the buffer stores at least one piece of buffered data, and the data acquisition unit includes circuitry further configured to:
search for, based on an address interval of the first part of data and an address interval of the buffered data, buffered data that comprises the first part of data of the target data.

13. The processing apparatus of claim 11, wherein the data acquisition unit includes circuitry further configured to:
acquire the first part of data from the memory in response to a determination that the first part of data has not been found in the buffer.

14. The processing apparatus of claim 13, wherein the data acquisition unit includes circuitry further configured to:
access the memory based on an address of the first part of data and a bit width of the memory to acquire data, the acquired data acquired comprising the first part of data.

15. The processing apparatus of claim 11, wherein the data acquisition unit includes circuitry further configured to:
access the memory based on an address of the second part of data and a bit width of the memory to acquire data, the acquired data comprising the second part of data.

16. The processing apparatus of claim 15, wherein the data acquisition unit includes circuitry further configured to:
specify, based on the bit width of the memory, a data length of data to be acquired by the access; and
specify, based on the address of the second part of data, an address of the data to be acquired by the access, the address being aligned to the data length.

17. The processing apparatus of claim 15, wherein the data acquisition unit includes circuitry further configured to:
after accessing the memory, store at least a part of the acquired data into the buffer as buffered data.

18. The processing apparatus of claim 11, wherein the data acquisition unit includes circuitry further configured to:
determine, based on an address interval of the target data and a bit width of the memory, at least one of the first part of data or the second part of data of the target data.

19. The processing apparatus of claim 18, wherein the data acquisition unit includes circuitry further configured to:
determine, based on the address interval of the target data and the bit width of the memory, a bit width boundary spanned by the target data; and
divide, based on the spanned bit width boundary, the target data into the first part of data and the second part of data.

20. The processing apparatus of claim 11, wherein an address of the target data in the address-unaligned data load instruction is not equal to an integer multiple of a data length of the target data.

21. The processing apparatus of claim 11, wherein the second part of data comprises a plurality of second parts of data, and the data acquisition unit includes circuitry configured to:
for each second part of data of the target data, access the memory based on an address of each second part of data and a bit width of the memory to acquire data, the acquired data comprising the second part of data.

22. A System on Chip comprising:
a memory; and
a processing apparatus communicatively coupled to the memory, the processing apparatus comprising:
a buffer configured to store buffered data;
an instruction executing unit having circuitry configured to execute an address-unaligned data load instruction, wherein the data load instruction is used to read target data from the memory and the instruction executing unit is coupled to the buffer and the memory;
a data acquisition unit having circuitry configured to acquire a first part of data of the target data from the buffer, the first part of data being data of a first plurality of bits in the target data, and to acquire a second part of data of the target data, the second part of data being data of a second plurality of bits in the target data; and
a data processing unit having circuitry configured to merge the first part of data and the second part of data to obtain the target data.
